(19) United States
(12) Patent Application Publication
(10) Pub. No.: US 2025/0051232 A1
(43) Pub. Date: Feb. 13, 2025

(54) SOLAR REFLECTIVE POLYMER-BASED GRANULES

(71) Applicant: Owens Corning Intellectual Capital, LLC, Toledo, OH (US)

(72) Inventors: Nardine Abadeer, Columbus, OH (US); William Smith, Pataskala, OH (US)

(21) Appl. No.: 18/723,687

(22) PCT Filed: Jan. 20, 2023
(86) PCT No.: PCT/US2023/060948

§ 371 Date: Jun. 24, 2024

Related U.S. Application Data
(60) Provisional application No. 63/301,792, filed on Jan. 21, 2022.

(51) Int. Cl. C04B 20/00; C04B 111/80; E04D 1/00; E04D 1/20

(52) U.S. Cl. CPC C04B 20/0016; E04D 1/20; C04B 2111/807; E04D 2001/005

(57) ABSTRACT

Solar reflective polymer-based granules are disclosed. Each of the solar reflective polymer-based granules includes a powder mixture including at least one functional pigment and a functional mineral filler and a polymer carrier extruded with the powder mixture. The at least one functional pigment is selected from the group consisting of an inorganic pigment, a white pigment, an infrared reflective pigment, and mixtures thereof. In various embodiments, the functional mineral filler is present in the polymer-based granules in an amount of from about 5 wt. % to about 80 wt. %, based on a total weight of the polymer-based granules. The resultant polymer-based granules have a solar reflectivity of greater than or equal to 8% when measured using a solar reflectometer.

### CROSS-REFERENCE TO RELATED APPLICATION(S)

This application claims priority to and all benefit of U.S. Provisional Patent Application No. 63/301,792, filed on Jan. 21, 2022, the entire disclosure of which is fully incorporated herein by reference

### BACKGROUND

Standard roofing granules are typically made of a raw base mineral stone material such as granite, covered with a ceramic coating that may contain clays, inorganic binders, and pigments. These roofing granules are applied to an asphalt shingle to protect the asphalt against degradation, to improve aesthetics, and to provide color. Specialty granules are often standard roofing granules with a coating containing various types of functional additives, such as pigments, to impart functional properties onto the granules and the shingle onto which the granules are deposited. For example, specialty granules may be utilized to increase or improve solar reflectivity in order to comply with local building codes or other efficiency guidelines. However, if dark pigments are used that absorb in the visible wavelength range but reflect in the near infrared wavelength range, the granules may be more expensive than standard colored or noncolored granules, which results in a more expensive roofing product. Further, the raw base stone material imparts limitations inherent to the granule's structure that limit the amount of improvability of the functional properties and limit the amount of reflectivity in dark mineral roofing granules Accordingly, there is a continuing need for alternative roofing granules that can impart functional properties to the shingle.

### BRIEF SUMMARY

Various embodiments described herein are directed to polymer-based granules that improve solar reflectivity in addition to providing protection to asphalt and providing color. Such polymer-based granules can also impart improved fire retardance, weathering, and UV opacity.

According to various embodiments, a solar reflective polymer-based granule is formed from a composition that includes a powder mixture including at least one functional pigment and, optionally, a functional mineral filler and a polymer carrier extruded with the powder mixture. The at least one functional pigment is selected from the group consisting of a white pigment, an infrared reflective pigment, and mixtures thereof. In various embodiments, the functional mineral filler is present in the polymer-based granules in an amount of from about 5 wt. % to about 80 wt. % based on a total weight of the polymer-based granule. The resultant polymer-based granule has a solar reflectivity of greater than or equal to 8% when measured using a solar reflectometer.

In various embodiments, a method of manufacturing solar-reflective polymer-based granules includes combining a functional mineral filler and at least one functional pigment to form a powder mixture. The at least one functional pigment is selected from the group consisting of an inorganic pigment, a white pigment, an infrared reflective pigment, and mixtures thereof. The method further includes extruding the powder mixture with a polymer carrier to form polymer-based granules. In various embodiments, the polymer-based granules have a solar reflectivity of greater than or equal to 8%.

According to various embodiments, a roofing shingle includes an asphalt-coated sheet, at least a portion of which has a plurality of solar reflective polymer-based granules disposed thereon. Each of the solar reflective polymer-based granules includes a powder mixture including at least one functional pigment and a functional mineral filler and a polymer carrier extruded with the powder mixture. The at least one functional pigment is selected from the group consisting of an inorganic pigment, a white pigment, an infrared (IR) reflective pigment and mixtures thereof. In various embodiments, the functional mineral filler is present in the polymer-based granules in an amount of from about 5 wt. % to about 80 wt. % based on a total weight of the polymer-based granules. The resultant polymer-based granules have a solar reflectivity of greater than or equal to 8% when measured using a solar reflectometer.

In various embodiments, a method of manufacturing a roofing shingle includes providing an asphalt-coated sheet and combining a functional mineral filler and at least one functional pigment to form a powder mixture. The at least one functional pigment is selected from the group consisting of an inorganic pigment, a white pigment, an infrared reflective pigment, and mixtures thereof. The method further includes extruding the powder mixture with a polymer carrier to form polymer-based granules, and applying the granule mixture to the asphalt coated sheet, thereby forming the roofing shingle. In various embodiments, the polymer-based granules have a solar reflectivity of greater than or equal to 8%.

### BRIEF DESCRIPTION OF THE DRAWINGS

The general inventive concepts, as well as embodiments and advantages thereof, are described in greater detail, by way of example, with reference to the drawings in which:

FIG. 1 graphically illustrates the impact of filler concentration on the solar reflectivity of polymer-based pellets;

FIG. 2 graphically illustrates the impact of IR black pigment concentration on the solar reflectivity of low-density polyethylene-based pellets;

FIG. 3 graphically illustrates the impact of IR black pigment concentration on the lightness and solar reflectivity of polymer-based pellets;

FIG. 4 graphically illustrates the impact of the type of filler and filler concentration on the solar reflectivity of low-density polyethylene pellets;

FIG. 5 is a schematic elevation view of an apparatus for making shingles according to one or more embodiments shown and described herein;

FIG. 6 is a perspective view of a laminated shingle formed on the apparatus of FIG. 5 and including a polymer-based granule according to one or more embodiments shown and described herein;

FIG. 7A is an image from a light microscope of the polymer-based granules of Comparative Sample J prior to weathering;

FIG. 7B is an image from a light microscope of the polymer-based granules shown in FIG. 7A following weathering for three months;

FIG. 8A is an image from a light microscope of the polymer-based granules of Sample H prior to weathering;

FIG. 8B is an image from a light microscope of the polymer-based granules shown in FIG. 8A following weathering for three months;

FIG. 9A is an image from a light microscope of the polymer-based granules of Sample K prior to weathering; and

FIG. 9B is an image from a light microscope of the polymer-based granules shown in FIG. 9A following weathering for three months.

### DETAILED DESCRIPTION

Several illustrative embodiments will be described in detail with the understanding that the present disclosure merely exemplifies the general inventive concepts. Embodiments encompassing the general inventive concepts may take various forms and the general inventive concepts are not intended to be limited to the specific embodiments described herein.

The general inventive concepts encompass solar reflective polymer-based granules and uses thereof, such as for roofing products, outdoor building materials, and the like. In addition to imparting solar reflectivity, the polymer-based granules can provide color, flame retardancy, and opacity. In various embodiments presented herein, the polymer-based granules are formed from a coextrusion of a polymer carrier with a powder mixture including at least one functional pigment and, optionally, a functional mineral filler. The functional pigment is a white pigment, an infrared reflective pigment, or a mixture thereof. When present, the functional mineral filler is present in the polymer-based granules in an amount of from about 5 wt. % to about 80 wt. %, based on a total weight of the polymer-based granules. The resultant polymer-based granules include a precise balance between polymer carrier, functional mineral filler, and functional pigment to achieve a solar reflectivity of greater than or equal to 8% or greater than or equal to 10% (also may be referenced as a solar reflectivity value of greater than or equal to 0.08 or 0.10) when measured with a solar reflectometer.

In various embodiments, the polymer-based granules include a polymer carrier that functions to bind the pellets together. The polymer carrier can include homopolymers or copolymers that are linear or branched. The polymer carrier may further include biodegradable polymers or copolymers, bio-sourced polymers, and/or recycled polymers. Copolymers can be random, alternating, or block. Examples of polymeric compounds include acrylic copolymers, polyesters, polyamides, epoxies, nonacid-containing polyolefins, polyolefin alloys, polypropylene, acid-containing polyolefins, polyvinyl chloride, polyester block amide, ethylene-chlorotrifluoroethylene, nylons, polyvinylidene fluoride, polycarbonates, polyanhydrides, poly(ortho esters), polyphosphoesters, and combinations thereof. In some embodiments, the polymer carrier can include a thermoplastic or thermoset polymeric material. In some embodiments, the polymeric carriers are selected from high density, low density, and linear low density polyethylene, polypropylene, low and high impact polystyrene, PVC, ABS, polyamides, polyesters, polycarbonate, polyvinyl chloride, polymethyl methacrylate, polyglycolic acid, polyhydroxy butyrate, polyurethanes, polyureas, epoxy, polydimethylsiloxane (PDMS), poly(styrene-butadiene-styrene) (SBS), styrene butadiene rubber (SBR), styrene-(ethylene/butylene)-crystalline block copolymer (SEBC), and acrylic. In any of the exemplary embodiments, the polymer carrier can include polyethylene, such as low-density polyethylene or polypropylene.

The polymer carrier is included in an amount greater than about 20 wt. %, including, for example, greater than about 25 wt. %, greater than about 30 wt. %, greater than about 35 wt. %, greater than about 45 wt. %, greater than about 50 wt. %, greater than about 55 wt. %, greater than about 60 wt. %, greater than about 65 wt. %, greater than about 70 wt. %, greater than about 75 wt. %, or greater than about 80 wt. %, based on a total weight of the polymer-based granules, including all numbers and end points therebetween. Additionally, the polymer carrier can be included in an amount less than about 99 wt. %, less than about 98 wt. %, less than about 95 wt. %, less than about 90 wt. %, less than about 85 wt. %, or less than about 80 wt. % based on a total weight of the polymer granules, including all numbers and end points therebetween. For example, the polymer carrier can be present in the polymer-based granules in an amount of from about 40 wt. % to about 99 wt. %, including, for example, from about 45 wt. % to about 95 wt. %, from about 50 wt. % to about 90 wt. %, from about 50 wt. % to about 80 wt. %, or from about 80 wt. % to about 99 wt. %, including any ranges or subranges therein.

In various embodiments, the polymer carrier is coextruded with a mixture including the functional mineral filler and the at least one functional pigment. Using filler can further increase solar reflectivity of the polymer-based pellets and therefore the shingles to which they are applied. For example, white functional mineral filler can provide opacity and reflectivity throughout the pellet, thus increasing solar reflectivity. In addition, pellets containing functional mineral filler can also be used to increase fire retardancy of the shingle. By way of non-limiting example, the functional mineral filler can be limestone, dolomite, fly ash, talc, calcium carbonate, kaolin, wollastonite, glass, nanofillers, silica, barium sulfate, zinc oxide, titanium dioxide, aluminum hydroxide, fumed silica, carbon black, magnesium hydroxide, diatomaceous earth, perlite, ball clay, iron oxide, and combinations or mixtures thereof.

The functional mineral filler can be included in an amount of greater than 0 wt. %, including, for example, greater than about 5 wt. %, greater than about 10 wt. %, greater than about 15 wt. %, or greater than about 20 wt. % based on a total weight of the polymer-based granules, including any numbers and end points therebetween. The functional mineral filler can be included in an amount of less than about 80 wt. %, including an amount less than about 75 wt. %, less than about 70 wt. %, less than about 65 wt. %, less than 60 wt. %, less than about 55 wt. %, less than about 50 wt. %, less than about 45 wt. %, less than about 40 wt. %, less than about 35 wt. %, less than about 30 wt. %, less than about 25 wt. %, or less than about 20 wt. %, based on a total weight of the polymer-based granules, including any numbers and end points therebetween. For example, the functional mineral filler can be included in the polymer-based granules in an amount of from about 5 wt. % to about 60 wt. %, from about 5 wt. % to about 50 wt. %, from about 5 wt. % to about 40 wt. %, from about 5 wt. % to about 30 wt. %, from about 5 wt. % to about 20 wt. %, from about 10 wt. % to about 50 wt. %, from about 10 wt. % to about 40 wt. %, from about 10 wt. % to about 30 wt. %, from about 10 wt. % to about 20 wt. %, from about 15 wt. % to about 40 wt. %, from about 15 wt. % to about 30 wt. %, or from about 15 wt. % to about 20 wt. % based on a total weight of the polymer-based granules, including any ranges and subranges included therein. However, in some embodiments, the functional mineral filler is not included in the polymer-based granules. Accordingly, in various embodiments, the functional mineral filler is an optional component.

The functional pigment can be any functional pigment capable of imparting a desired property into the polymer-based granule. In various embodiments, the functional pigment is capable of at least imparting solar reflectivity to the polymer-based granules. By way of non-limiting example, the functional pigment can be an inorganic pigment, a white pigment, or an infrared (IR) reflective pigment. White pigments include, for example, titanium dioxide, zinc oxide, aluminum hydrate, barium sulfate, talc, silica, zinc sulfide, lithopone, barytes, china clay, antimony white, cremnitz white, lead carbonate, or mixtures thereof. When included, the white pigment can also improve opacity and fire retardancy of the polymer-based granules. IR reflective pigments include any dark, cool pigments, for example, IR black pigments, IR brown pigments, IR blue pigments, IR green pigments, IR red pigments, IR yellow pigments, IR orange pigments, or mixtures thereof. Other color IR pigments can be known and used, depending on the embodiment. As used herein, a “cool pigment” refers to a pigment that absorbs light in the visible wavelengths, and reflects light in the near IR wavelengths. When included, the IR reflective pigments can also improve opacity, modify the color of the polymer-based granules, and reflect IR light.

The functional pigment is included in the polymer-based granules in an amount of greater than 0 wt. %, greater than about 5 wt. %, greater than about 10 wt. %, or greater than about 15 wt. % based on a total weight of the polymer-based granules, including any numbers and end points therebetween. The functional pigment is included in an amount of less than about 40 wt. %, including an amount less than 35 wt. %, less than 30 wt. %, less than 25 wt. %, less than 20 wt. %, less than about 18 wt. %, less than about 15 wt. %, less than about 12 wt. %, or less than about 10 wt. %, based on a total weight of the polymer-based granules, including any numbers and end points therebetween. For example, the functional pigment can be included in the polymer-based granules in an amount of from greater than 0 wt. % to about 40 wt. %, including, for example, from about 0.1 wt. % to about 25 wt. %, from about 0.15 wt. % to about 20 wt. %, from about 0.3 wt. % to about 18 wt. %, from about 0.5 wt. % to about 15 wt. %, from about 0.5 wt. % to about 10 wt. %, from about 0.5 wt. % to about 5 wt. %, from about 1 wt. % to about 20 wt. %, from about 1 wt. % to about 15 wt. %, from about 1 wt. % to about 10 wt. %, or from about 1 wt. % to about 5 wt. % based on a total weight of the polymer-based granules, including any ranges and subranges included therein.

The amount of the functional pigment included can be based on the type of functional pigment included in the polymer-based granules. For examples, when the functional pigment is a white pigment, it can be included in an amount of from greater than 0 wt. % to about 20 wt. %, including any ranges and subranges included therein, while an IR reflective pigment can be included in an amount of from about greater than 0 wt. % to about 20 wt. %, and preferably between about 0.1 wt. % and 10 wt. %, including any ranges and subranges included therein. However, amounts and types of functional pigments, including combinations of functional pigments, can vary depending on the particular embodiment.

By the very nature of the pigments, dark pigments have inherently low solar reflectivity and thus, until now, it has been challenging to utilize dark colored granules in applications that require some levels of solar reflectivity. However, it has been surprisingly discovered that dark IR reflective pigments can be used in the subject polymer-based granules, while still achieving a solar reflectivity of greater than or equal to 0.1 (10%), when measured with a solar reflectometer.

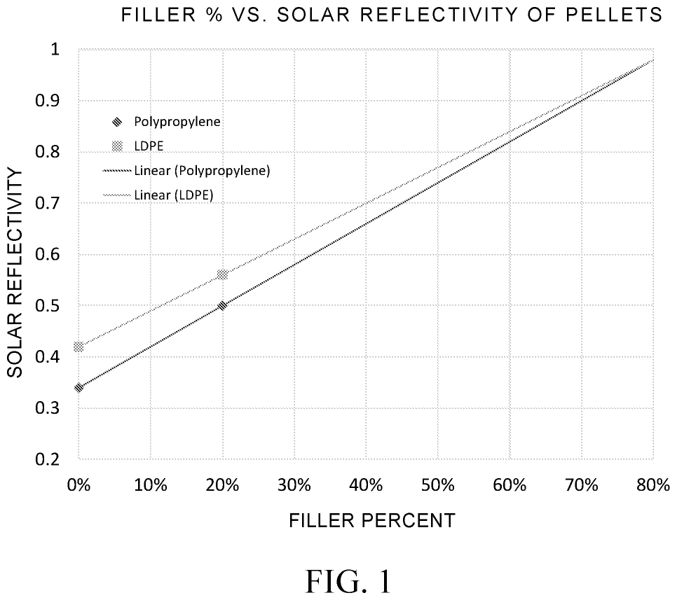

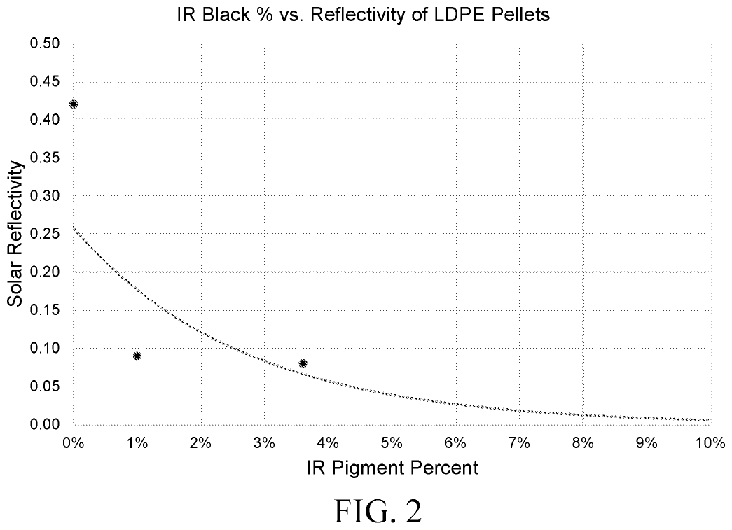

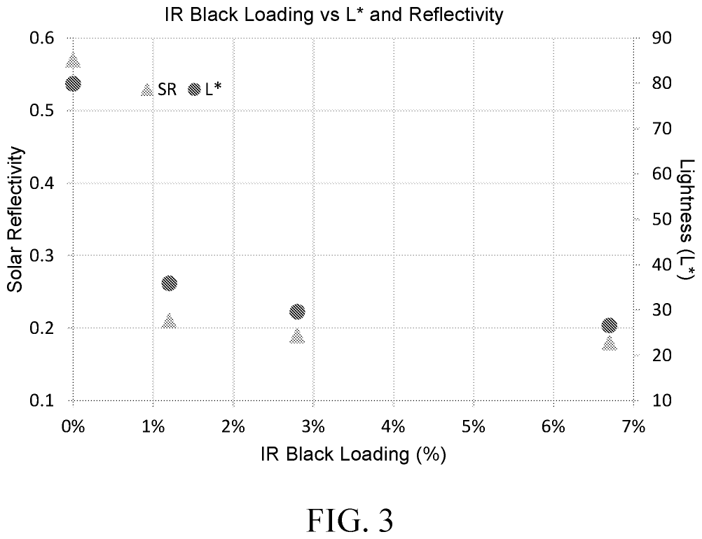

Thus, the amount of polymer, functional mineral filler, and functional pigment must be precisely balanced to achieve a solar reflectivity of at least 0.1, and preferably at least 0.2. As illustrated in FIG. 1, adding functional mineral filler (in this instance calcium carbonate filler) to a polypropylene-based or low-density polyethylene-based pellet generally increases the granules' solar reflectivity. However, the addition of a dark IR reflective pigment tends to have the opposite effect, decreasing the granule's solar reflectivity to less than 0.1 after the addition of 1.0 wt. % of the pigment, as illustrated in FIG. 2 (trendline regression extrapolated to demonstrate further reduction in solar reflectivity with increasing IR black pigment concentration). The general relationship between color lightness (L*) and solar reflectivity is further illustrated in FIG. 3, whereby an increasing loading concentration of IR black pigment relatively consistently decreases both lightness and solar reflectivity. Thus, the challenge has been to achieve dark granule or pellet colors, while maintaining sufficient reflectivity.

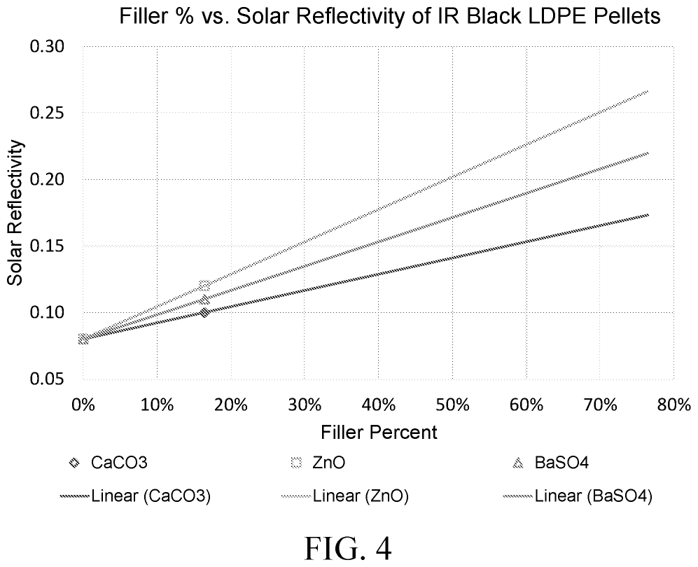

Accordingly, the balance between polymer, functional mineral filler must be particularly selected to ensure that sufficient solar reflectivity can be maintained, even in the case of dark pigments. Moreover, the type of functional mineral filler used impacts the amount required to counterbalance the negative effect on solar reflectivity caused by the IR reflective pigment. Particularly, as illustrated in FIG. 4, a low-density polyethylene-based granule including 3.6 wt. % of an IR reflective pigment requires at least 16.4 wt. % of a calcium carbonate functional mineral filler to achieve a solar reflectivity of 0.1, with slightly less needed when using a zinc oxide or barium sulfate filler (extrapolation of the trendline indicative of further increase in solar reflectivity over increased filler percentages).

Optionally, the polymer-based granules can also include other components such as curing agents or hardeners, extenders, flow modifiers, UV blockers or absorbers, light stabilizers, antioxidants, thermal stabilizers, compatibilizers, other thermoplastics, flame retardants, inorganic pigments, and the like. When included, a UV absorber or light stabilizer can reduce photodegradation of granules, thereby reducing or preventing cracking, retaining color or improving color retention, and extending the lift of the granule. UV absorbers can include, by way of example and not limitation, benzotrazoles, benzophenones, organic nickel compounds, and other UV absorbers known and used in the art. In some embodiments, the polymer-based granules include hindered amine light stabilizers. When included in the polymer-based granules, the light stabilizer or UV absorbers can be included in an amount of greater than 0 wt. % to about 10 wt. %, or from about 0.5 wt. % to about 5 wt. %, based on a total weight of the polymer-based granules, including any ranges and subranges included therein.

Optionally, inorganic pigments may be incorporated into the polymer-based granules to deliver color and flame retardants may be incorporated to inhibit or retard ignition and burning of the polymer-based granules. In any of the exemplary embodiments, the polymer-based granules may be used on asphalt shingles to meet or exceed the standards set forth in ASTM E108 Class A and UL 790 Class A. Any of these optional, additional components can be included in the polymer-based granules in an amount of greater than 0 wt. % to about 20 wt. %, such as from about 0.5 wt. % to about 15 wt. % or from about 1 wt. % to about 10 wt. %, including any ranges and subranges included therein. The particular combination of additives and the amounts thereof vary depending on the particular embodiment.

In various embodiments, the resultant polymer-based granules have a solar reflectivity of greater than or equal to at least about 8% or greater than equal to at least about 10%, when measured using a solar reflectometer. For example, the polymer-based granules can have a solar reflectivity of greater than about 8%, greater than about 10%, greater than about 15%, greater than about 20%, greater than about 25%, or greater than about 30%. In any of the exemplary embodiments, the polymer-based granules can have a solar reflectivity of from about 8% to about 80%, from about 10% to about 80%, from about 20% to about 60%, or from about 20% to about 55%, or from about 20% to about 50%, or from about 20% to about 35%, including any ranges and subranges included therein.

As described above, in any of the exemplary embodiments, the functional mineral filler may improve the fire retardancy of the polymer-based granules and, accordingly, the shingle on which the polymer-based granules are disposed. The resultant polymer-based granules can also have a time to ignition of greater than about 5 minutes, greater than about 7.5 minutes, or even greater than about 10 minutes. As used herein, the “time to ignition” refers to the time to ignition when polymer-based granules are placed in an aluminum plate and heated from below with a 2-inch flame.

In various embodiments, the polymer-based granules are formed by first mixing a powder or granulated mixture including the functional pigment, the functional mineral filler, and any additional additive (e.g., UV blockers, flame retardants, etc.) to form a mixture. The mixing can be carried out, for example, using a ball mill, vortex mixer, attritor milling, or any other mixing method or apparatus commonly known and used in the art. In some embodiments, the functional pigment, functional mineral filler, and any additional additive can be added to the extruder to form the powder mixture. The mixture can then optionally be dried in an oven at a temperature of 100° C. to remove moisture ahead of extrusion.

Next, the powder mixture is extruded with the polymer carrier to form a polymer composite. In any of the exemplary embodiments, the co-extrusion can be carried out using a twin-screw extruder, although other extrusion methods known in the art can be used depending on the particular embodiment. The polymer composite is pulled from the twin-screw extruder and chopped to produce pellets of a defined width, length, height, and density. In any of the embodiments, the pellets can be cylindrical-shaped, although other sizes and shapes are known and suitable for the granules. For example, in various embodiments, each of the width, length, and diameter are independently selected to be from about 0.2 mm to about 3 mm, including from about 0.5 mm to about 2 mm, from about 0.5 mm to about 1.5 mm, or from about 0.5 mm to about 1.2 mm, including any ranges and subranges included therein. In any of the exemplary embodiments, the polymer-based granules can have a density of from about 0.3 g/mL to about 3 g/mL, from about 0.5 g/mL to about 3 g/mL, or from about 1 g/mL to about 1.5 g/mL. It is contemplated that the particular shape and size of the polymer-based granules can vary on the specific embodiment and can be controlled using process parameters.

The resultant polymer-based granules are deposited onto the shingle in an amount suitable to provide the shingle with the desired properties. In any of the exemplary embodiments, the polymer-based granules described herein may be used as the primary or main granule on the shingle, or can be applied to the surface of the shingle at a lower percentage. As used herein, the term “primary granule” or “main granule” refers to the granule that is present in greatest amount by volume based on a total volume of the granules deposited on the shingle. For example, the polymer-based granules can be deposited at an average of about 1% to 100%, about 2-100%, or about 2-10% of the total granules applied to the surface of the shingle, including any ranges and subranges included therein. Other granules, including traditional roofing granules and other specialty granules can be deposited on the surface of the shingle. These other granules can be deposited during the same or during a separate step as the deposition of the polymer-based granules described herein.

Although described herein as being deposited onto shingles, in other embodiments, the polymer-based granules can be used in any one of a variety of applications. For example, the polymer-based granules can be deposited on surfacing material for other solar reflective applications, including but not limited to roads, siding, flooring, flat roofs, and the like.

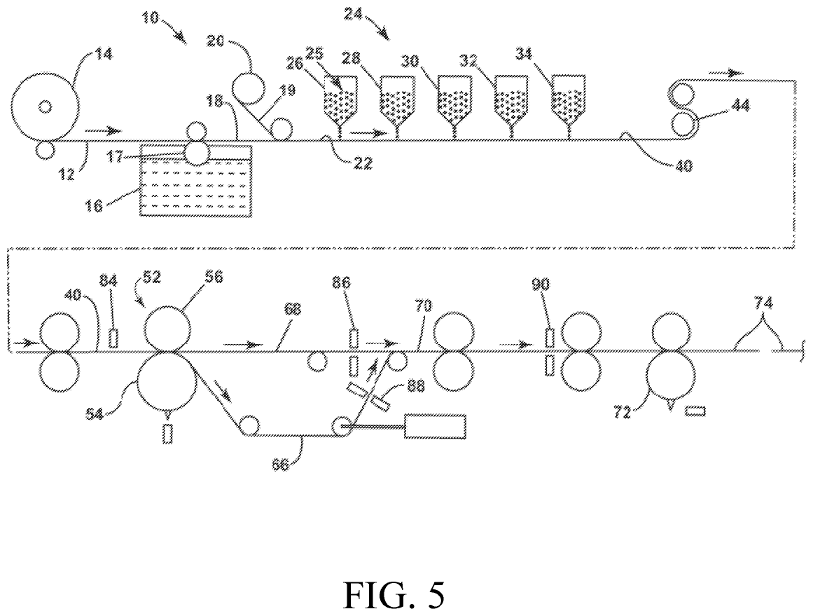

FIG. 5 illustrates an example apparatus 10 for manufacturing an asphalt-based roofing material according to a manufacturing process wherein a continuous sheet is passed in a machine direction (indicated by the arrows) through a series of manufacturing operations. The sheet can pass at a speed of at least about 200 feet/minute (61 meters/minute), and can pass at a speed within the range of between about 450 feet/minute (137 meters/minute) and about 800 feet/minute (244 meters/minute) or even at or above 1200 feet/minute. The sheet, however, can move at any desired speed.

The manufacturing process continues as the continuous sheet of substrate or shingle mat 12 is payed out from a roll 14. The substrate can be any type known for use in reinforcing asphalt-based roofing materials, such as a non-woven web of glass fibers. The shingle mat 12 is fed through a coater 16 where an asphalt coating is applied to the shingle mat 12. The asphalt coating can be applied in any suitable manner. In one example, the shingle mat 12 contacts a roller 17, which is in contact with a supply of hot, melted asphalt. The roller 17 completely covers the shingle mat 12 with a tacky coating of hot, melted asphalt to define a first asphalt coated sheet 18. Alternatively, the asphalt coating can be sprayed on, rolled on, or applied to the first asphalt coated sheet 18 by any other suitable means.

Next, and optionally, a continuous strip of a reinforcement material or reinforcement tape 19, is payed out from a roll 20. The reinforcement tape 19 adheres to the first asphalt coated sheet 18 to define a second asphalt coated sheet 22. In any of the exemplary embodiments, the reinforcement tape 19 can be attached to the first asphalt coated sheet 18 by the adhesive mixture of the asphalt in the first asphalt coated sheet 18. Alternatively, the reinforcement tape 19 can be attached to the first asphalt coated sheet 18 by any suitable means, such as other adhesives. In any of the exemplary embodiments, the reinforcement tape 19 can be formed from polyester. In other embodiments, the reinforcement tape 19 can be formed from polyolefin, such as polypropylene or polyethylene, and can include any polymeric material having the desired properties for the finished product and which endures the manufacturing environment. The reinforcement tape 19 can be formed from any material which preferably reinforces and strengthens the nail zone of a shingle, such as, by way of non-limiting example, paper, film, scrim material, and woven or non-woven fibers, such as glass, natural or polymer fibers. Alternatively, the reinforcement tape 19 can be formed of any material that does not provide such physical properties, but simply provides an indicia of the nail zone.

The second asphalt coated sheet 22 passes beneath a series of granule dispensers 24 for the application of granules to the upper surface of the second asphalt coated sheet 22. The granule dispensers 24 can be of any type suitable for depositing granules 25 onto the asphalt coated sheet. In an exemplary embodiment, a series of granule dispensers 24 can include one or more color blenders, for example, the series of granule dispensers 24 can include four color blend blenders 26, 28, 30, and 32 and a background blender 34. Any desired number of color blenders, however, can be used. Moreover, the granule dispensers 24 can dispense alternate forms of granules such as specialty granules defined below. Specialty granules, including the polymer-based granules described herein, can be applied with a separate granule dispenser or can be mixed into any of the four color blend blenders 26, 28, 30, and 32 and/or the background blender 34. Alternatively, granules 25 can be dispensed onto the second asphalt coated sheet 22 by any means suitable for dispensing granules 25. After all the granules 25 are deposited on the second asphalt coated sheet 22 by the series of granule dispensers 24, the second asphalt coated sheet 22 becomes a granule covered sheet 40.

To the extent a reinforcement tape is provided, the reinforcement tape 19 can include an upper surface to which the granules 25 will not substantially adhere. The reinforcement tape 19, alternatively, can include an upper surface to which the granules 25 will adhere. For example, the apparatus 10 can include any desired means for depositing the granules 25 onto substantially the entire second asphalt coated sheet 22, except for the portion of the second asphalt coated sheet 22, covered by the reinforcement tape 19, as best shown in FIG. 2. Alternately, the granules 25 can be deposited onto substantially the entire second asphalt coated sheet 22, including the reinforcement tape 19, where the reinforcement tape 19 includes an upper surface to which the granules 25 substantially will not adhere.

The granule covered sheet 40 is turned around a slate drum 44 to press the granules 25 into the asphalt coating and to temporarily invert the granule covered sheet 40 so that the excess granules will fall off and can be recovered and reused. Next, the granule covered sheet 40 is fed through a rotary pattern cutter 52 having a bladed cutting cylinder 54 and a backup roll 56. Optionally, the pattern cutter 52 can cut a series of cutouts in the tab portion of the granule covered sheet 40, and cut a series of notches in the underlay portion of the granule covered sheet 40.

The pattern cutter 52 can also cut the granule covered sheet 40 into a continuous underlay sheet 66 and a continuous overlay sheet 68. The underlay sheet 66 can be aligned beneath the overlay sheet 68, and the two sheets 66, 68 can be laminated together to form a continuous laminated sheet 70. The continuous underlay sheet 66 can be routed on a longer path than the path of the continuous overlay sheet 68. Further downstream, the continuous laminated sheet 70 is passed into contact with a rotary length cutter 72 that cuts the laminated sheet into individual laminated shingles 74.

In order to facilitate synchronization of the cutting and laminating, various sensors and controls can be employed. For example, sensors, such as photo eyes 86 and 88 can synchronize the continuous underlay sheet 66 with the continuous overlay sheet 68. Sensors 90 can synchronize the notches and cutouts of the continuous laminated sheet 70 with the end cutter or length cutter 72.

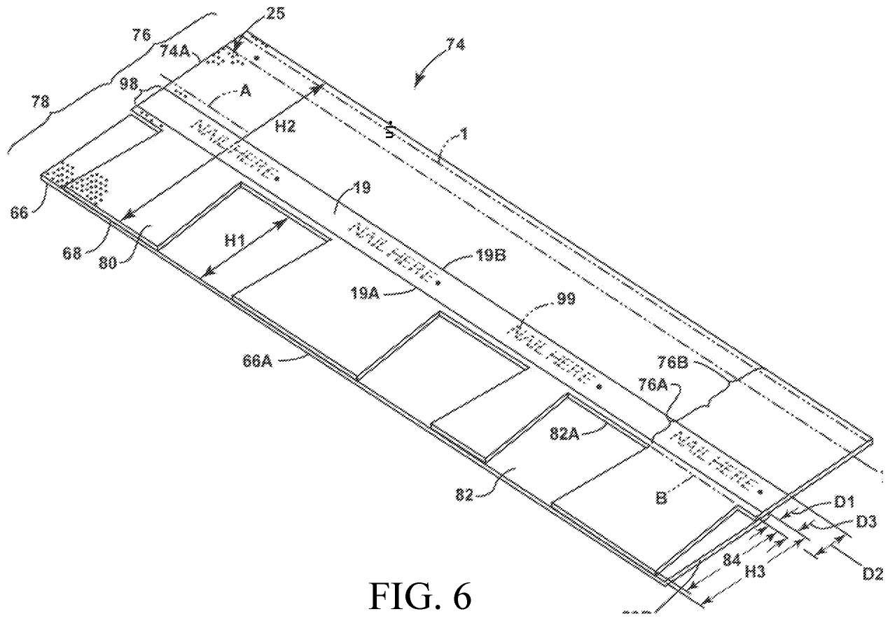

Referring now to FIG. 6, an example laminated roofing shingle 74 is illustrated according to aspects described herein. The shingle 74 includes the overlay sheet 68 attached to the underlay sheet 66. The shingle 74 has a first end 74A, a second end 74B, and a longitudinal axis A. The overlay sheet 68 includes a headlap portion 76 and a tab portion 78. The headlap portion 76 includes a lower zone 76A and an upper zone 76B. The tab portion 78 defines a plurality of tabs 80 alternating a plurality of cutouts 82 such that each of the plurality of cutouts 82 can be located between each adjacent tab 80. By way of non-limiting example, the tab portion 78 can include four tabs 80, although any suitable number of tabs 80 can be provided. The headlap portion 76 and the tabs 80 can include one or more granule patterns thereon.

Each cutout 82 has a first height H1. As illustrated in FIG. 6, each cutout 82 has the same height H1 as another cutout 82. It will be understood, however, that each cutout 82 can have a different height H1 as another cutout 82. A line B, collinear with an upper edge 82A of the cutouts 82, defines an upper limit of an exposed region 84 of the underlay sheet 66.

In embodiments, the height of the exposed region 84 is equal to the first height H1, however, the height of the exposed region 84 may be any desired height, and the top of the cutouts 82 need not be collinear as illustrated. In a shingle 74 wherein the cutouts 82 have different first heights H1, the line B can alternatively be collinear with an upper edge 82A of the cutout 82 having the largest height H1.

The reinforcement tape 19 is located longitudinally on the headlap portion 76 from the first end 74A to the second end 74B of the shingle 74 within the lower zone 76A of the headlap portion 76. A lower edge 19A of the reinforcement tape 19 is spaced apart from the line B by a distance D1, and an upper edge 19B of the reinforcement tape 19 is spaced apart from the line B by a distance D2. By way of non-limiting example, the distance D1 is within the range of from about ¼ inch to about ¾ inch. In another example, the distance D1 is about ½ inch. In yet another example, the distance D2 is within the range of from about 1¾ inches to about 2¼ inches. In another example, the distance D2 is about 2 inches. The distances D1 and D2 can, however, be of any other desired length, including zero for D1. For example, in embodiments, the reinforcement tape 19 substantially covers the entire headlap portion 76 of the overlay sheet 68. It will be further understood, however, that one or more additional lengths of reinforcement tape 19 can be disposed longitudinally on the headlap portion 76, even outside the nail zone, such as shown by the phantom line 19′. It will be understood that the reinforcement material need not extend from the first end 74A to the second end 74B of the shingle 74, and can be disposed in one or more sections or portions on the shingle 74.

The reinforcement tape 19 can define a nail zone 98 and can optionally include indicia 99. By way of non-limiting example, the indica 99 can be text such as “nail here”, as shown in FIG. 6. It will be understood, however, that any other text or other indicia can included on the reinforcement tape 19. It will also be understood that the reinforcement tape 19 can be provided without such text or indicia. Such indicia 99 on the reinforcement tape 19 ensure that the nail zone 98 may be easily and quickly identified by the shingle installer.

The overlay sheet 68 has a second height H2. The underlay sheet 66 includes a leading edge 66A, a trailing edge 66B, and has a third height H3. The trailing edge 66B of the underlay sheet 66 is spaced apart from the line B by a distance D3. As illustrated, the distance D3 is about ¾ inch, however, the distance D3 may be any desired distance.

The third height H3 of the underlay sheet 66 is less than one-half the second height H2 of the overlay sheet 68. The overlay sheet 68 and the underlay sheet 66 thereby define a two-layer portion of the laminated shingle 74 and a single-layer portion of the laminated shingle 74, wherein at least a portion of the reinforcement tape 19 is preferably adhered to the single-layer portion of the laminated shingle 74. Alternately, the third height H3 of the underlay sheet 66 may be equal to one-half the second height H2 of the overlay sheet 68, or greater than one-half of the second height H2 of the overlay sheet 68. Such a relationship between the underlay sheet 66 and the overlay sheet 68 allows the reinforcement tape 19 to be positioned such that a reinforced nail zone is provided at a substantially single-layer portion of the shingle 74.

In the exemplary shingle 74 illustrated in FIG. 6, the shingle 74 has a nail pull-through value, preferably measured in accordance with a desired standard, such as prescribed by ASTM test standard D3462. For example, the shingle 74 may have a nail pull-through value that is greater than in an otherwise identical shingle having no such reinforcement tape 19. The shingle 74 can have a nail pull-through value within-the range of from about ten percent to about 100 percent greater than in an otherwise identical shingle having no such reinforcement tape 19. Alternatively, the shingle 74 can have a nail pull-through value about 50 percent greater than in an otherwise identical shingle having no such reinforcement tape 19.

The granules 25 applied to the upper surface of the second asphalt coated sheet 22 can include any granule type known in the art, including conventional granules and the polymer-based granules disclosed herein.

### EXAMPLES

### Example 1

Polymer-based granules were produced using ball milling, extrusion, and pelletizing equipment, as described above. The extruder metered the polymer, functional pigments, and additives at the desired percentages.

TABLE 1

| | Reflec- | | Reflec- |
|---|---|---|---|
| Example | tivity | Comparable | tivity |
| Sample A - white | 0.65 | Comparative Sample A - white | 0.39 |
| Sample B - red | 0.27 | Comparative Sample B - red | 0.25 |
| Sample C - yellow | 0.47 | Comparative Sample C - | 0.30 |
| | | reflective tan | |

Each of the polymer-based granules of Samples A, B, and C were made using 50% by weight of low-density polyethylene, 48% by weight of limestone filler, and 2% by weight of corresponding pigment. Comparative Samples A, B, and C are commercially available IR reflective rock-based granules. Reflectivity was measured by a reflectometer using the ASTM C1549 testing methodology. As illustrated by the results of Table 1 above, the reflectivity of the polymer-based granules is higher when compared to current rock-based solar reflective granules designed to provide enhanced solar reflectivity.

### Example 2

Additional samples and comparative samples were prepared to further explore the solar reflectivity properties of granules including various combinations of additives and pigments. Each of the granules were prepared as described above, and reflectivity was measured by a reflectometer using the ASTM C1549 testing methodology. For the Samples and Comparative Samples in Table 2, the IR black pigment was NB803-K (available from Ferro) and the CaCO₃ filler was G3 (available from Imerys). The amounts of polymer carrier, functional mineral filler, and IR pigment reported in Table 2 are the amounts in weight percent (wt. %) based on a total weight of the polymer-based granule.

TABLE 2

| | | | Functional | | | | Solar | |
|---|---|---|---|---|---|---|---|---|
| Sample | Polymer Carrier | | mineral filler | | IR Pigment | | Reflectivity | Color |
| Comparative | Polypropylene | 100 | n/a | | n/a | | 0.34 | White |
| Sample D | | | | | | | | |
| Comparative | Polypropylene | 80 | CaCO₃ | 20 | n/a | | 0.50 | White |
| Sample E | | | | | | | | |
| Comparative | LDPE | 100 | n/a | | n/a | | 0.42 | White |
| Sample F | | | | | | | | |
| Comparative | LDPE | 80 | CaCO₃ | 20 | n/a | | 0.56 | White |
| Sample G | | | | | | | | |
| Comparative | LDPE | 98.9 | n/a | | IR | 1.1 | 0.09 | Black |
| Sample H | | | | | black | | | |
| Comparative | LDPE | 96.4 | n/a | | IR | 3.6 | 0.08 | Black |
| Sample I | | | | | black | | | |
| Sample D | LDPE | 80 | CaCO₃ | 16.4 | IR | 3.6 | 0.10 | Black |
| | | | | | black | | | |
| Sample E | LDPE | 80 | ZnO | 16.4 | IR | 3.6 | 0.12 | Gray |
| | | | | | black | | | |
| Sample F | LDPE | 80 | BaSO₄ | 16.4 | IR | 3.6 | 0.11 | Black |
| | | | | | black | | | |

As demonstrated by the data of Table 2, the addition of a white functional mineral filler (e.g., CaCO₃) is effective to increase the reflectivity. The addition of a black pigment reduces reflectivity, with increased amounts of pigment leading to a greater reduction in reflectivity. However, the addition of a functional mineral filler is effective to increase the reflectivity even in the presence of the black pigment. The data in Table 2 further demonstrates that pure LDPE has increased reflectivity over polypropylene.

Additional samples and comparative samples were prepared as described above to explore the effects of UV blockers and other IR reflective pigments. For the samples and comparative samples in Table 3, the IR black pigment was 10G996, IR brown pigment #1 was 10P857, and IR brown pigment #2 was 10P850, all available from Shepherd. The CaCO₃ filler was G3 (available from Imerys), and the UV blocker was Hostavin 3070P (available from Clariant). The amounts of polymer carrier, functional mineral filler, and IR pigment reported in Table 3 are the amounts in weight percent (wt. %) based on a total weight of the polymer-based granule. As the particular IR pigments have different compositions and therefore different reflectivity, the overall impact on solar reflectivity may be slightly different for each distinct IR pigment.

TABLE 3

| | Polymer | | Functional | | | | UV | Solar | |
|---|---|---|---|---|---|---|---|---|---|
| Sample | Carrier | | mineral filler | | IR Pigment | | Blocker | Reflectivity | Color |
| Comparative | LDPE | 54 | CaCO₃ | 46 | n/a | | n/a | 0.57 | white |
| Sample J | | | | | | | | | |
| Comparative | LDPE | 54 | CaCO₃ | 45 | n/a | | 1 | 0.57 | white |
| Sample K | | | | | | | | | |
| Sample G | LDPE | 54 | CaCO₃ | 39.3 | IR | 6.7 | n/a | 0.18 | Black |
| | | | | | black | | | | |
| Sample H | LDPE | 54 | CaCO₃ | 42.1 | IR | 2.8 | 1.1 | 0.19 | Black |
| | | | | | black | | | | |
| Sample I | LDPE | 54 | CaCO₃ | 44.8 | IR | 1.2 | n/a | 0.21 | Black |
| | | | | | Black | | | | |
| Sample J | LDPE | 54 | CaCO₃ | 41 | IR | 5.0 | n/a | 0.28 | Light |
| | | | | | Brown 1 | | | | brown |
| Sample K | LDPE | 54 | CaCO₃ | 41 | IR | 5.0 | n/a | 0.26 | Dark |
| | | | | | Brown 2 | | | | brown |

The data in Table 3 demonstrates that increased functional mineral filler content results in increased reflectivity, and the addition of the UV blocker does not appear to influence reflectivity. Additionally, by comparing the data from Table 3 to the data of Table 2, it can be seen that the IR black pigment utilized in Samples G-I delivers greater reflectivity than the IR black pigment utilized in Comparative Samples H and I and Samples D-F. Moreover, a decrease in the pigment concentration leads to an increase in reflectivity, and lighter IR reflective pigments delivery slightly increased levels of reflectivity.

### Example 3

The fire performance of various of the polymer-based granules of Table 2 was further explored and compared with fire performance of commercially available ceramic granules (“Comparative Sample—Commercially Available”). Fire testing was completed by putting 2.5 g of polymer-based granules or 10 g of ceramic granules in an aluminum plate and heating from below with a 2-inch flame burning at approximately 1200° F. The difference in weight of granules was selected based on the density of the granules in order to maintain a similar sample volume. The time to ignition was measured up to 10 minutes. The time to ignition in minutes and comments for each of the samples is reported in Table 4 below.

TABLE 4

| | Time to | |
|---|---|---|
| | Ignition | Notes |
| Comparative Sample | >10 | Good fire retardancy |
| (Commercially | | |
| Available) | | |
| Comparative Sample D | 4 | Ignited easily |
| Comparative Sample E | 4:55 | Inorganic filler slightly improved |
| | | fire resistance |
| Comparative Sample F | 2:14 | Ignited very easily |
| Comparative Sample G | >10 | Inorganic filler significantly |
| | | improved fire retardancy |
| Comparative Sample H | 4:20 | Low level of inorganic pigment |
| | | slightly improved fire retardancy |
| Comparative Sample I | >10 | High level of inorganic pigment |
| | | significantly improved fire retardancy |
| Sample D | >10 | High level of inorganic pigment and |
| | | filler significantly improved fire |
| | | retardancy |
| Sample F | >10 | High level of inorganic pigment and |
| | | filler significantly improved fire |
| | | retardancy |

In general, the polymer-based granules melted, then some began smoking and eventually ignited. Polymer-based granules that did not ignite often had a higher level of filler and/or inorganic pigment, which is believed to have prevented the polymer carrier from igniting. As shown in Table 4, the LDPE ignited more quickly than the polypropylene. It was also observed that the inorganic materials appeared to form a protective crust, which appeared to reduce access to organics and also reduced smoking. Based on the effects of the filler and pigments, it is believed that granule formulations can be tuned to improve fire performance while providing improving solar reflectivity.

### Example 4

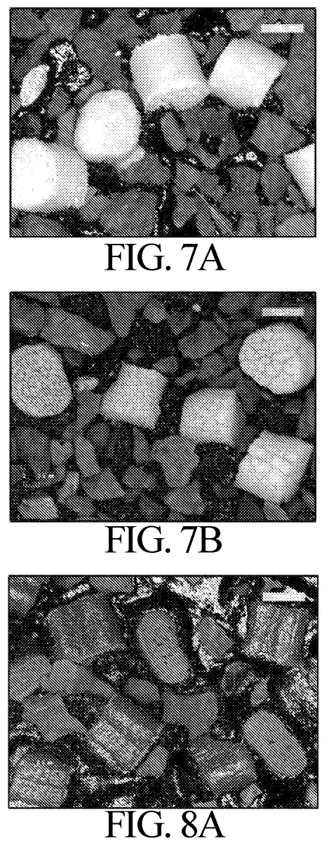

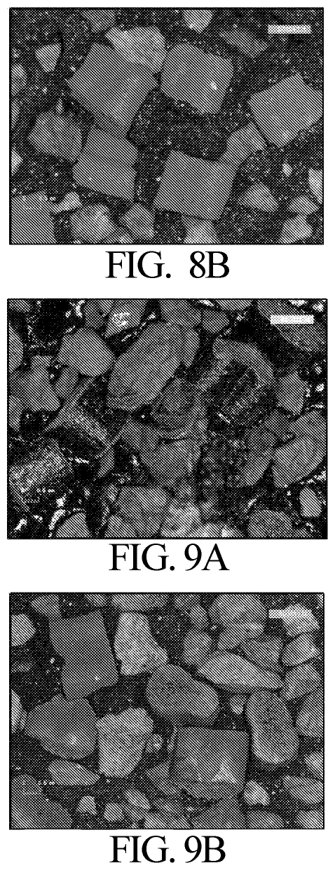

The weathering stability of various polymer-based granules of Table 3 was further explored. Polymer-based granules were applied to shingle prototypes and aged in an Atlas Weatherometer (WOM) for three (3) months. The WOM settings are outlined in ASTM D4798. Images before and after weathering were taken using a light microscope to evaluate changes in morphology and are presented in FIGS. 7A-9B. Visual observations are reported in Table 5 below.

TABLE 5

| Sample | Observations |
|---|---|
| Comparative Sample J | Yellowing and cracking of granule surface |
| Sample H | Some fading of color, but less visible cracking |
| Sample K | Some fading of color, but less visible cracking |

In general, the polymer-based granules without the pigment showed cracking after the weathering. However, pellets prepared with pigment, with or without a UV blocker, showed less visible cracking. This suggests that pigments and other additives can reduce or even prevent degradation under weathering.

### Example 5

Ultraviolet (UV) light can be damaging to shingles. Typically, opaque particles on the surface of the shingles are used to prevent degradation of the asphalt shingle by reducing UV transmittance through the surfacing material. However, the use of organic materials, such as polymers, is likely to increase UV transmittance. Accordingly, UV transmittance of various samples and comparative samples from Table 2 was measured.

To measure UV transmittance, 1.50 g of each sample was melted on a hot plate until a complete melt of the sample was achieved. For samples containing polypropylene, a hotplate temperature of 250° C. was used, while for samples including LDPE, a hotplate temperature of 160° C. was used to allow the samples to reach their internal melting temperature. The melted samples were then allowed to cool to form a film, removed from their respective sampling cups, and measured with calipers to determine a thickness for each of the samples. The thickness of each of the sample films was 2 mm.

Spectral analysis of each of the sample films was carried out to determine a percent transmittance. Each sample was analyzed from 1500-200 nm in double beam mode with a spectral bandwidth of 2 nm. The percent light transmittance at 400 nm was recorded and is provided in Table 6 below.

TABLE 6

| | % Transmittance |
|---|---|
| Sample | (400 nm) |
| Comparative Sample D | 5.4% |
| Comparative Sample E | 0.2% |
| Comparative Sample F | 0.9% |
| Comparative Sample G | 0.3% |
| Comparative Sample H | 0.0% |
| Comparative Sample I | 0.0% |
| Sample D | 0.0% |
| Sample E | 0.0% |

As shown by the data in Table 6, the addition of filler and/or IR reflective pigment can eliminate UV light transmittance. Accordingly, various embodiments herein may be effective to reduce or prevent UV degradation of asphalt in the roofing shingles.

It should be recognized that certain desired properties in rock-based granules are limited by simply the nature of the granule itself. For example, in rock-based granules, the amount of reflectivity obtainable is limited because of the inherent light absorbing nature of the natural rock material that forms the granule itself. Therefore, the flexibility of additive types, fillers available and filler properties, as well as polymer attributes allow for expanded capabilities of polymer-based granules to impart desired functional properties to a roofing product as compared to rock-based granules.

To the extent not already described, the different features and structures of the various embodiments of the present disclosure may be used in combination with each other as desired. For example, one or more of the features illustrated and/or described with respect to one aspect of the disclosure can be used with or combined with one or more features illustrated and/or described with respect to other aspects of the disclosure. That one feature may not be illustrated in all of the embodiments is not meant to be construed that it cannot be, but is done for brevity of description. Thus, the various features of the different embodiments may be mixed and matched as desired to form new embodiments, whether or not the new embodiments are expressly described.

While aspects of the present disclosure have been specifically described in connection with certain specific embodiments thereof, it is to be understood that this is by way of illustration and not of limitation. Reasonable variation and modification are possible within the scope of the forgoing disclosure and drawings without departing from the spirit of the present disclosure which is defined in the appended claims.

1. A solar-reflective polymer-based granule formed from a composition comprising:
a powder mixture comprising:
at least one functional pigment selected from the group consisting of an inorganic pigment, a white pigment, an infrared reflective pigment, and mixtures thereof; and
a functional mineral filler; and
a polymer carrier extruded with the powder mixture,
wherein the functional mineral filler is present in the polymer-based granule in an amount of from about 5 wt. % to about 80 wt. % based on a total weight of the polymer-based granule, and wherein the polymer-based granule has a solar reflectivity of greater than or equal to 8% when measured using a solar reflectometer.

2. The solar-reflective polymer-based granule of claim 1, wherein the polymer carrier comprises high density polyethylene, low density polyethylene, polypropylene, polystyrene, PVC, acrylonitrile butadiene styrene (ABS), polyamides, polyesters, polycarbonate, polyvinyl chloride, polymethyl methacrylate, polyglycolic acid, polyhydroxy butyrate, polyurethanes, polyureas, epoxy, polydimethylsiloxane (PDMS), poly(styrene-butadiene-styrene) (SBS), styrene butadiene rubber (SBR), styrene-(ethylene/butylene)-crystalline block copolymer (SEBC), acrylic, or mixtures thereof.

3. The solar-reflective polymer-based granule of claim 1, wherein the functional mineral filler comprises at least one of limestone, dolomite, fly ash, talc, barium sulfate, zinc oxide, calcium carbonate, kaolin, wollastonite, glass, nanofillers, silica, titanium dioxide, aluminum hydroxide, fumed silica, carbon black, magnesium hydroxide, diatomaceous earth, perlite, ball clay, iron oxide, and combinations or mixtures thereof.

4. The solar-reflective polymer-based granule of claim 1, wherein the functional mineral filler is present in the polymer-based granule in an amount of from about 5 wt. % to about 60 wt. % based on the total weight of the polymer-based granule.

5. The solar-reflective polymer-based granule of claim 4, wherein the functional mineral filler is present in the polymer-based granule in an amount of from about 15 wt. % to about 20 wt. % based on the total weight of the polymer-based granule.

6. The solar-reflective polymer-based granule of claim 1, wherein the polymer carrier is present in an amount of from about 20 wt. % to about 99 wt. % based on the total weight of the polymer-based granule.

7. The solar-reflective polymer-based granule of claim 1, wherein the polymer carrier is present in an amount of from about 80 wt. % to about 99 wt. % based on the total weight of the polymer-based granule.

8. The solar-reflective polymer-based granule of claim 1, wherein the at least one functional pigment is present in the polymer-based granule in an amount of greater than 0 wt. % to about 20 wt. % based on the total weight of the polymer-based granule.

9. The solar-reflective polymer-based granule of claim 1, wherein the at least one functional pigment is an infrared reflective pigment.

10. The solar-reflective polymer-based granule of claim 9, wherein the infrared reflective pigment is present in an amount of from about 0.1 wt. % to about 10 wt. % based on the total weight of the polymer-based granule.

11. The solar-reflective polymer-based granule of claim 1, wherein the at least one functional pigment is a white pigment selected from the group consisting of zinc oxide, titanium oxide, barium sulfate, and combinations thereof.

12. The solar-reflective polymer-based granule of claim 1, wherein the polymer-based granule further comprises a UV blocker or light stabilizer.

13-39. (canceled)
